(19) United States
(12) Patent Application Publication
(10) Pub. No.: US 2024/0420868 A1
(43) Pub. Date: Dec. 19, 2024

(54) SUBSEA POWER CABLE

(71) Applicant: NEXANS, Courbevoie (FR)

(72) Inventors: Audun JOHANSON, OSLO (NO); Massimiliano MAURI, BORGENHAUGEN (NO)

(21) Appl. No.: 18/742,849

(22) Filed: Jun. 13, 2024

(30) Foreign Application Priority Data
Jun. 15, 2023 (EP) 23315249.5

(51) Int. Cl. H01B 7/282; H01B 7/14; H01B 13/22

(52) U.S. Cl. CPC H01B 7/2825; H01B 7/14; H01B 13/22

(57) ABSTRACT

A method of manufacture for a subsea power cable (100), includes the step of providing at least one cable core (125) having an electrical conductor (110) and an electrically insulating system (120) arranged radially outside of the electrical conductor (110). The method includes adding a liquid material having a polymer, on top of the at least one cable core (125), forming a buffer layer (130); and applying a water barrier (140) radially outside of the buffer layer (130).

### RELATED APPLICATION

This application claims the benefit of priority from European Patent Application No. 23 315 249.5, filed on Jun. 15, 2023, the entirety of which is incorporated by reference.

### FIELD OF THE INVENTION

The present invention relates to a subsea power cable comprising a water barrier, especially a lead-free water barrier.

### BACKGROUND

The current carrying parts of subsea power cables may need to be kept dry. Intrusion of humidity or water may cause electrical breakdown of the power cable insulation system. The core section of power cables is therefore usually protected by a water barrier arranged radially around the cable core. Up to date, the dominating material in water barriers for power cables is lead since lead has proven to be a reliable and sturdy sheathing material.

Several solutions for insulation systems providing water barriers to submarine power cables are known, but all have various disadvantages that should be overcome. One drawback is that lead is a high-density materiel adding significant weight to the cable. The heavy weight induces extra costs in the entire value chain from production, under transport, storage, deployment, and when the cable is discarded after reaching its lifetime. Another drawback is that lead has a relatively low fatigue resistance making leaden water barriers less suited for dynamical power cables. Furthermore, lead is a rather poisonous material increasingly meeting environmental regulation restrictions. An environmentally friendly replacement of lead as water barrier in power cables is required.

EP2312591 relates to a submarine power cable comprising an electrical conductor surrounded by an insulation, said insulation being surrounded by a metallic moisture barrier. The cable further comprises a semi-conductive adhesive layer surrounding the metallic moisture barrier and a semi-conductive polymeric jacket able to be in electrical contact with sea water surrounding said semi-conductive adhesive layer, the overlaying of the metallic moisture barrier, the semi-conductive adhesive layer and the semi-conductive polymeric jacket forming a 3-layer sheath.

EP3438993 relates to a method of manufacturing a dynamic power cable comprising the steps of
providing a cable core comprising; an electrical conductor and an electrically insulating layer arranged radially outside of the electrical conductor,
wrapping a metallic sheet radially around the cable core, the metallic sheet comprising a copper-nickel alloy,
welding together opposing edges of the metallic sheet to form a continuous water barrier layer around the cable core, wherein the welding is performed by autogenous welding.

EP3786982 relates to a power cable, comprising:
an electric conductor,
an electric insulating material enclosing the electric conductor, and
an inner sheathing enclosing the electric insulating material enclosing the electric conductor, wherein the inner sheathing is made of a CuNiSi-alloy.

Thin, high-resistance metallic screens and laminate solutions are coming up as candidate alternatives to replace lead, but have significant drawbacks and issues related to high-voltage testing and short-circuit current capacity. Due to these issues, the current power cable structures do not allow the use of high-resistance metallic screen, as the power cable may even be quickly damaged and become unfit for use.

The present invention attempts to solve these challenges, or at least to improve on existing solutions.

### SUMMARY OF THE INVENTION

The present invention is defined by the appended claims and in the following:

In a first aspect, the invention relates to a method for manufacturing of a subsea power cable, the method comprising the steps of:
a) providing at least a cable core comprising an electrical conductor and an electrically insulating system, arranged radially outside of the electrical conductor;
b) adding a liquid material comprising a polymer, radially outside of the at least one cable core, thereby forming a buffer layer; and
c) applying a water barrier layer radially outside of the buffer layer,

wherein a viscosity of the liquid material of the buffer layer (130) is at least 1000 mPa·s.

In an embodiment, the liquid material may be in direct contact with electrical conductor.

In an embodiment, the liquid material may be in direct contact with the water barrier layer.

In an embodiment, the steps of the method are carried out in order a, then b, then c.

In an embodiment, the electrically insulating system may preferably comprise
an inner layer made of a first semiconducting material for surrounding the electric conductor,
an intermediate insulating layer made of an insulating material, covering an external surface of the inner semiconducting layer,
an outer layer made of a second semiconducting material, covering an external surface of the insulating layer.

This method is advantageous because the buffer layer supports the water barrier layer during production and results in a cable (especially the water barrier layer) that is less prone to deformation during production and installation of the cable.

The cable produced by this method is also advantageous especially as a dynamic cable, as it will be more resistant to fatigue.

In an embodiment, the method may further comprise the step of:
d) hardening the buffer layer.

Hardening the buffer layer further improves the support provided by the buffer layer to the water barrier layer during production and results in a cable (especially the water barrier layer) that is less prone to deformation, in particular during production and installation of the cable. Hardening the buffer layer also makes the cable more resistant to physical shocks.

In an embodiment, the volume of the buffer layer after hardening in step d) may be at least 75% of the volume of the buffer layer after step c).

In an embodiment, the volume of the buffer layer after hardening in step d) is at least 80%, 90%, 95%, 99% or 99.5% of the volume of the buffer layer after step c).

In an embodiment, the volume of the buffer layer after hardening in step d) may be between 75% and 100% of the volume of the buffer layer after step c).

Choosing a liquid material that shrinks as little as possible during the hardening step will ensure that there is as little space as possible between the buffer layer and the water barrier layer. Space between these layers may leave the water barrier layer susceptible to mechanical collapse under external pressure.

In an embodiment, the liquid material may comprise a foam.

In an embodiment, the liquid material may comprise a natural or synthetic rubber.

In an embodiment, the liquid material may comprise Styrene-butadiene rubbers (SBR), Nitrile-butadiene rubbers (NBR), Hydrogenated Nitrile rubbers (HNBR), Fluorine rubbers or fluoro-rubbers (FKM), Fluorosilicone Rubbers (FVMQ), Polybutadiene (PBD), Polychloroprene (CR), Polyisoprene (IR/NR), Butyl rubber (IIR), Polyisobutylene (PIB), Silicone rubbers, Poly(a-olefin)s, Ethylene propylene rubber (EPR), Ethylene propylene diene monomer (M-class) rubber (EPDM rubber), Polyethylene and its copolymers, for example polyethyelene copolymers of acrylates (Acrylic copolymers (AC)), methacrylates, acetates (Ethylene-vinyl acetate (EVA)), Low-density polyethylene (LDPE), Linear low-density polyethylene (LLDPE), Very-low-density polyethylene (VLDPE), Medium-density polyethylene (MDPE), Polymethyl pentene (PMP), Polybutene-1 (PB-1), Ethylene-octene copolymers, Olefin block copolymers, Propylene-butane copolymers, Flexible poly vinyl chloride (PVC), Polyurethanes (PU), Polyimides (PA), Neoprene (also polychloroprene) (CR) and any combination thereof.

In an embodiment, the liquid material may comprise an isocyanate prepolymer and an active-hydrogen-containing materials (polyols, polyamines etc.) reacting together to form a polyurethane (PU). The isocyanate needs to have at least 2 functionalities (a diisocyanate) such as methylene diphenyl diisocyanate or toluene diisocyanate. The active-hydrogen-containing materials also needs at least 2 functionalities: polyols can be ester-based or ether-based, with terminal hydroxyl groups (the reactive part).

In an embodiment, the liquid material may comprise polyols based on polyesters (caprolactones, adipates, castor oil and transesterification derivatives thereof), based on polyethers [poly(oxypropylene), poly(oxypropylene-co-oxyethylene), poly(1,4-oxybutylene)] or hydroxy-containing hydrocarbon polymers (hydroxy-containing butadiene homopolymers and copolymers).

In an embodiment, the step of applying the water barrier layer may comprise the steps of:
providing a metal plate;
surrounding the buffer layer with the metal plate,
welding the metal plate to form the water barrier layer.

Here the person skilled in the art will understand surrounding the at least one cable core with the metal plate, means that the metal plate is wrapped around the cable core. Welding the metal plate means jointing the edges of the metal plate that are adjacent to each other after wrapping the metal plate around the cable core. Jointing may be achieved by welding the edges of the metal plate using any known welding method, for example by longitudinal welding.

In an embodiment, the method may comprise the step of corrugating the water barrier layer.

The corrugated water barrier layer helps reduce local stresses in the water barrier during bending or tension of the cable and as such prolong its fatigue life and reduce its minimum bending radius. A water barrier layer may collapse under hydrostatic pressure if it is not supported, however that is not the case here because the buffer layer supports the corrugated water barrier layer, which helps keep the advantageous properties of the corrugated water barrier layer when using the cable as a subsea power cable. These properties of the corrugated water barrier layer are particularly advantageous for dynamic cables.

In a second aspect, the invention relates to a subsea power cable, the power cable comprising:
at least one cable core comprising an electrical conductor and an electrically insulating system that is arranged radially outside of the electrical conductor,
a buffer layer arranged radially outside of the at least one cable core,
a water barrier layer, arranged radially outside of the buffer layer
wherein the buffer layer is made of liquid material comprising a polymer and a viscosity of the liquid material of the buffer layer (130) is at least 1000 mPa·s.

In an embodiment, the water barrier layer may be a lead-free water barrier layer.

The term “lead-free” as applied here refers to metallic screen comprising less than 5%, less than 4%, less than 3%, less than 2%, less than 1%, less than 0.5%, less than 0.4%, less than 0.3%, less than 0.2%, less than 0.1%, less than 0.05%, or preferably comprising 0% lead.

In an embodiment, the water barrier layer may be made of:
aluminium,
an aluminium alloy of the AA1xxx series, AA5xxx series or the AA6xxx series according to the Aluminium Association Standard,
copper
a copper-alloy
a CuNi-alloy
a CuNi-alloy comprising between 2 and 30 wt % Ni
a CuNiSi-alloy age hardened to T6,
iron
a Fe-alloy
stainless steel alloy SS316-stainless steel alloy S32750.
titanium or Ti-alloy
or
Sn- or Sn alloy.

In an embodiment, the water barrier layer may be made of a Cu-alloy, preferably pure copper or a CuNi-alloy.

In an embodiment, the water barrier layer may have a corrugated geometry.

A corrugated layer refers to a layer that has been shaped into a series of parallel ridges and grooves, known as corrugations. These corrugations create a pattern of alternating peaks and valleys along the surface of the material, or wave pattern characterized by an amplitude and a period. The wave pattern may propagate in a longitudinal direction or in an helical direction.

In an embodiment, the water barrier layer may have a smooth geometry.

A smooth geometry refers to a layer that does not present corrugations or wave pattern. In other word, the layer has a surface texture without any visible irregularities (other than potential defects), such as any visible ridges or grooves.

In an embodiment, the buffer layer may be directly adjacent to the water barrier layer.

In an embodiment, the liquid material may have a viscosity of between 1000 mPa·s and 1 000 000 mPa·s.

In an embodiment, the liquid material may have a viscosity of between 2000 mPa·s and 200 000 mPa·s.

In an embodiment, the liquid material may have a viscosity of between 2 000 mPa·s and 50 000 mPa·s, of between 50 000 mPa·s and 100 000 mPa·s, or of between 100 000 mPa·s and 200 000 mPa·s.

In an embodiment, the liquid material may comprise a natural or synthetic rubber or a polymer.

In an embodiment, the liquid material may comprise Styrene-butadiene rubbers (SBR), Nitrile-butadiene rubbers (NBR), Hydrogenated Nitrile rubbers (HNBR), Fluorine rubbers or fluoro-rubbers (FKM), Fluorosilicone Rubbers (FVMQ), Polybutadiene (PBD), Polychloroprene (CR), Polyisoprene (IR/NR), Butyl rubber (IIR), Polyisobutylene (PIB), Silicone rubbers, Poly(a-olefin)s, Ethylene propylene rubber (EPR), Ethylene propylene diene monomer (M-class) rubber (EPDM rubber), Polyethylene and its copolymers, for example polyethyelene copolymers of acrylates (Acrylic copolymers (AC)), methacrylates, acetates (Ethylene-vinyl acetate (EVA)), Low-density polyethylene (LDPE), Linear low-density polyethylene (LLDPE), Very-low-density polyethylene (VLDPE), Medium-density polyethylene (MDPE), Polymethyl pentene (PMP), Polybutene-1 (PB-1), Ethylene-octene copolymers, Olefin block copolymers, Propylene-butane copolymers, Flexible poly vinyl chloride (PVC), Polyurethanes (PU), Polyimides (PA), Neoprene (also polychloroprene) (CR) and any combination thereof.

In an embodiment, the liquid material is a semi-conductive material.

The term “semi-conductive” as used herein, refers to middle level of electric conductivity, i.e. an electric conductivity falling between the electric conductivity of an electric conductor and an electric insulator.

All these layers may be used in combination with an adhesive layer, for example between the sheath layer and the buffer layer (such as yparex, etc.).

In an embodiment, the power cable may further comprise a polymer sheath and a second buffer layer, the second buffer layer arranged between the polymer sheath and the water barrier layer.

In an embodiment, the second buffer layer may comprise a second liquid material.

In an embodiment, the second liquid material has a viscosity of at least 1000 mPa·s.

In an embodiment, the second buffer layer may be directly adjacent to the water barrier layer.

In an embodiment, the second liquid material may comprise a natural or synthetic rubber or a polymer.

In an embodiment, the second liquid material may comprise Styrene-butadiene rubbers (SBR), Nitrile-butadiene rubbers (NBR), Hydrogenated Nitrile rubbers (HNBR), Fluorine rubbers or fluoro-rubbers (FKM), Fluorosilicone Rubbers (FVMQ), Polybutadiene (PBD), Polychloroprene (CR), Polyisoprene (IR/NR), Butyl rubber (IIR), Polyisobutylene (PIB), Silicone rubbers, Poly(a-olefin)s, Ethylene propylene rubber (EPR), Ethylene propylene diene monomer (M-class) rubber (EPDM rubber), Polyethylene and its copolymers, for example polyethyelene copolymers of acrylates (Acrylic copolymers (AC)), methacrylates, acetates (Ethylene-vinyl acetate (EVA)), Low-density polyethylene (LDPE), Linear low-density polyethylene (LLDPE), Very-low-density polyethylene (VLDPE), Medium-density polyethylene (MDPE), Polymethyl pentene (PMP), Polybutene-1 (PB-1), Ethylene-octene copolymers, Olefin block copolymers, Propylene-butane copolymers, Flexible poly vinyl chloride (PVC), Polyurethanes (PU), Polyimides (PA), Neoprene (also polychloroprene) (CR) and any combination thereof.

In an embodiment, the second liquid is a semi-conductive material.

In an embodiment, the first buffer layer and the second buffer layer are made of the same material. In an embodiment, the first buffer layer and the second buffer layer are made of different materials.

In a third aspect, the invention relates to a method for manufacturing of a joint for a subsea power cable, the method comprising the steps of:
a) providing a first subsea power cable and a second subsea power cable, each cable comprising at least one cable core and a water barrier layer,
b) jointing the at least one cable core of the first and a second subsea power cables, thereby forming at least one cable core joint;
c) adding a liquid material comprising a polymer, radially outside of the at least one cable core joint, thereby forming a buffer layer joint; and
d) applying a water barrier joint radially outside of the buffer layer joint, and welding the water barrier joint to the water barrier layer of the first subsea power cable and second subsea power cable.

In a fourth aspect, the invention relates to a subsea power cable joint, the power cable joint comprising:
at least one cable core joint comprising an electrical conductor joint and an electrically insulating system joint that is arranged radially outside of the electrical conductor joint;
a buffer layer arranged radially outside of the electrically insulating system;
a water barrier joint, arranged radially outside of the buffer layer;

wherein the buffer layer is made of liquid material comprising a polymer.

### SHORT DESCRIPTION OF THE DRAWINGS

In the following description this invention will be further explained by way of exemplary embodiments shown in the drawings:

FIG. 1 is a side view of a power cable 100 and a metal sheet 240.

FIG. 2 is a side view of the metal sheet 240 applied on the power cable 100.

FIG. 3 is a side view of the power cable 100 with a water barrier layer 140.

FIG. 4 is a side view of the power cable 100 with a water barrier layer 140 after addition of the buffer layer 130.

FIG. 5 is a side view of the power cable 100 with a water barrier layer 140 and a buffer layer 130 after diameter reduction.

FIG. 6 shows a transverse cross-sectional view through a first embodiment of a power cable according to the invention.

FIG. 7 shows a transverse cross-sectional view through a second embodiment of a power cable according to the invention.

### DETAILED DESCRIPTION OF THE INVENTION

The current carrying parts of power cables may need to be kept dry. Intrusion of humidity or water may cause electrical breakdown of the power cable insulation system. The core section of power cables is therefore usually protected by a water barrier arranged radially around the cable core. Up to date, the dominating material in water barriers for power cables is lead since lead has proven to be a reliable and sturdy sheathing material.

However, lead is a rather poisonous material increasingly meeting environmental regulation restrictions. An environmentally friendly replacement of lead in water barrier layer in power cables is required.

The invention therefore relates to a novel method and a novel structure for a power cable 100 comprising a metallic water barrier layer 140.

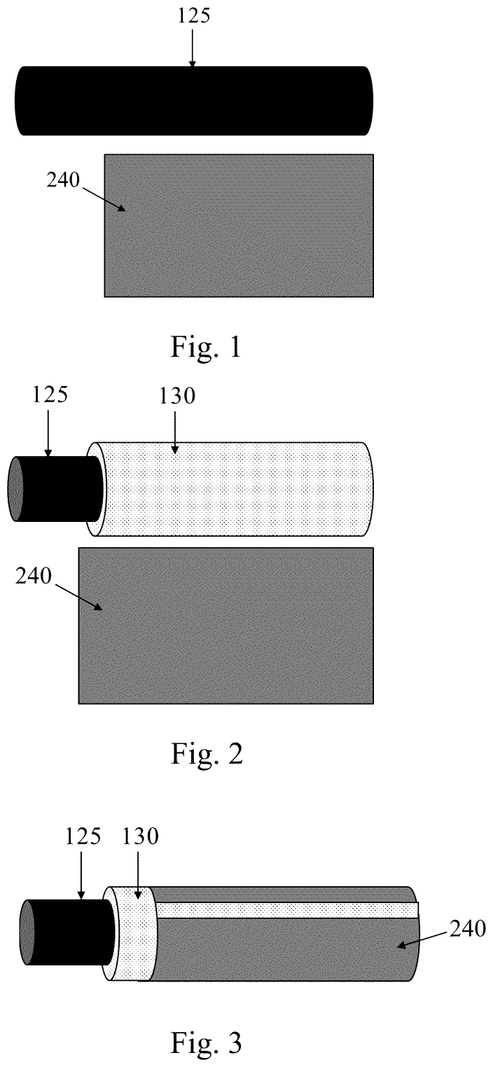

The method of manufacture for a subsea power cable 100 is illustrated in FIG. 1 to FIG. 5.

As shown in FIG. 1, a first step is to provide a power core 125 and a metal sheet 240.

It should be noted that the power core 125 is shown somewhat simplified in FIG. 1.

In FIGS. 6 and 7, it is shown that the cable core 125 comprising an electrical conductor 110 and an electrically insulating system 120 that is arranged radially outside of the electrical conductor 110.

The insulating system 120 here comprises
an inner layer 121 made of a first semiconducting material for surrounding the electric conductor 110,
an intermediate insulating layer 122 made of an insulating material, covering an external surface of the inner semiconducting layer 121,
an outer layer 123 made of a second semiconducting material, covering an external surface of the insulating layer 122.

It is now referred to FIG. 2, where a next step of the method is illustrated. Here, a liquid material comprising a polymer is added radially outside of the outer layer 123 of the cable core 125, thereby forming a buffer layer 130.

Then, as shown in FIG. 3, the metal sheet 240 is applied radially outside the buffer layer 130.

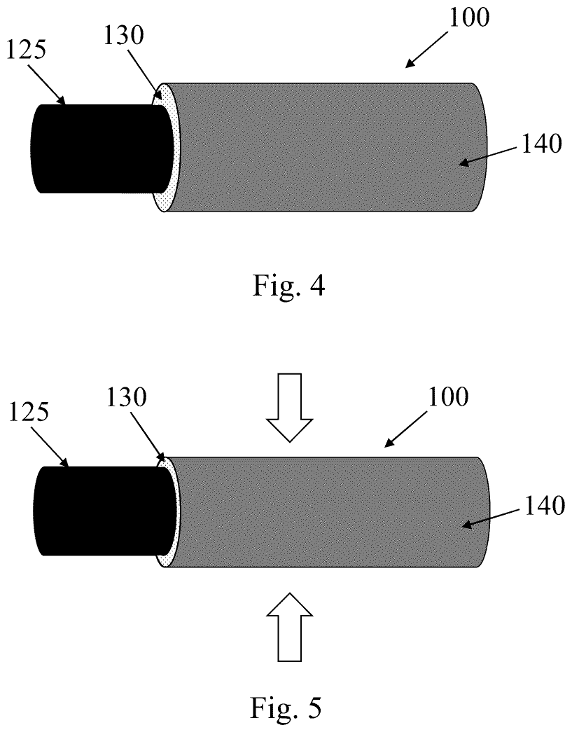

The metal sheet 240 is then welded, as shown in FIG. 4, for example by longitudinal welding, thereby forming a water barrier layer 140.

For example, the metal sheet 240 is first uncoiled around the cable core 125. The metal sheet 240 is subsequently continuously welded in the cable axial direction by moving the cable core 125 and formed metal sheet 240 in the process direction. The power core 125 is now fully sealed by the water barrier layer 140 which is made from the metallic sheet 240.

The metallic water barrier layer 140 can be further formed to multiple geometries:
Smooth barrier layer
Corrugated barrier layer: The water barrier layer 140 is formed to a corrugated geometry described by periodically shaped variations of the diameter of the water barrier layer 140. The geometry is described by the amplitude and associated period of the diameter of the water barrier layer 140. The period can be aligned with the axis of the cable core 125 or helical.

In the case of both smooth and corrugated water barrier layer 140, the water barrier layer 140 can be intentionally non-pressure resistant. That is: the water barrier layer 140 structure would collapse under hydrostatic water pressure. If so, the cable core 125 or other potential buffer layers must support the water barrier layer 140.

The buffer layer 130 ensures that the water barrier layer 140 is supported. It is advantageous here to use a liquid during manufacture instead of solid material, such as a tape. In this way, the liquid buffer layer 130 takes the shape of the space between the cable core 125 and the water barrier layer 140 and thus ensure a better support of the water barrier layer 140, especially for corrugated geometry.

The buffer layer 130 may or may not substantially change its properties after application for example by hardening the buffer layer 130.

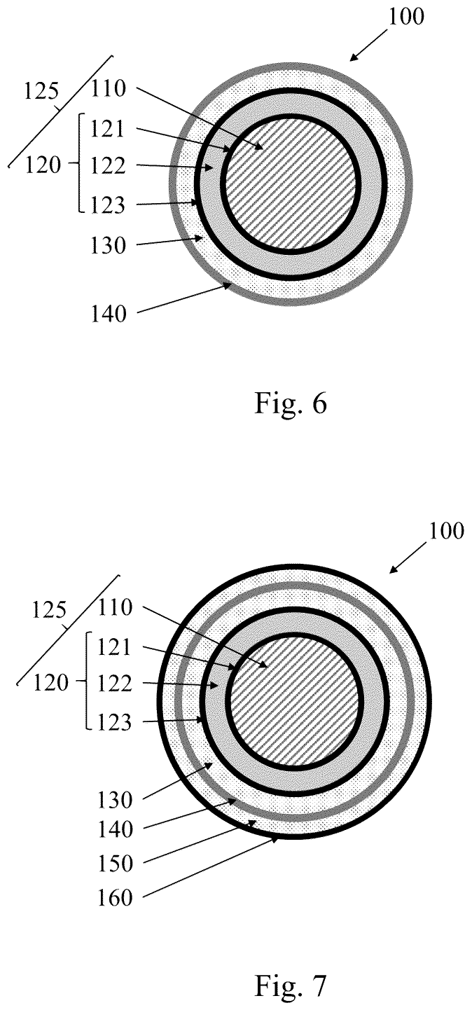

The water barrier layer 140 may in addition be reduced in diameter to better fit the diameter of the core. The water barrier layer 140 will typically be reduced to a round geometry by draw-down or rolling steps, or a non-round shape if needed (typically if the cable core is not round), as shown in FIG. 5.

This technology is especially relevant
for thin walled water barrier layer formed to a circular geometry,
when the at least one cable core 125 is non-circular, oval or otherwise.
for a corrugated water barrier layer where the thickness and/or period of the water barrier layer 140 is too low to prevent collapse.

A cross sectional view of the resulting power cable 100 is shown in FIG. 6. In this first embodiment, the power cable 100 comprises a cable core 125 as described above. The power cable 100 further comprises a buffer layer 130 arranged radially outside of the cable core 125, and a water barrier layer 140, arranged radially outside of the buffer layer 130, wherein the buffer layer 130 is made of liquid material comprising a polymer.

A second embodiment/example is shown in FIG. 7. Here the power cable 100, further comprises, as described in FIG. 7, a second buffer layer 150 and a polymer sheath 160, the second buffer layer 150 arranged between the polymer sheath 160 and the water barrier layer 140.

The second buffer layer 150 is preferably produced by applying a liquid material between the water barrier layer 140 and the polymer sheath 160.

The above methods are also adapted to produce a joint.

1. A method for manufacturing of a subsea power cable, the method comprising the steps of:
a) providing at least a cable core comprising an electrical conductor and an electrically insulating system, arranged radially outside of the electrical conductor;
b) adding a liquid material comprising a polymer, radially outside of the at least one cable core, thereby forming a buffer layer; and
c) applying a water barrier layer radially outside of the buffer layer,
wherein a viscosity of the liquid material of the buffer layer is at least 1000 mPa·s.

2. The method according to claim 1, further comprising the step of:
d) hardening the buffer layer.

3. The method according to claim 2 wherein the volume of the buffer layer after hardening in step d) is at least 75% of the volume of the buffer layer after step c).

4. The method according to claim 1, wherein the step of applying the water barrier layer comprises the steps of:
providing a metal plate;
surrounding the buffer layer with the metal plate;
welding the metal plate to form the water barrier layer.

5. The method according to claim 1, wherein the method comprises the step of:
corrugating the water barrier layer.

6. A subsea power cable, the power cable comprising:
at least one cable core comprising an electrical conductor and an electrically insulating system that is arranged radially outside of the electrical conductor;
a buffer layer arranged radially outside of the at least one cable core;
a water barrier layer, arranged radially outside of the buffer layer;
wherein the buffer layer is made of liquid material comprising a polymer and a viscosity of the liquid material of the buffer layer is at least 1000 mPa·s.

7. The power cable according to claim 6, wherein the water barrier layer is a lead-free water barrier layer.

8. The power cable according to claim 6, wherein the water barrier layer is made of:
aluminium,
an aluminium alloy of the AA1xxx series, AA5xxx series or the AA6xxx series according to the Aluminium Association Standard,
copper
a copper-alloy
a CuNi-alloy
a CuNi-alloy comprising between 2 and 30 wt % Ni
a CuNiSi-alloy age hardened to T6,
iron
a Fe-alloy
stainless steel alloy SS316-stainless steel alloy S32750.
titanium or Ti-alloy
or
Sn- or Sn alloy.

9. The power cable according to claim 6, wherein the water barrier layer is made of a Cu-alloy, preferably pure copper or a CuNi-alloy.

10. The power cable according to claim 6, wherein the water barrier layer has a smooth geometry.

11. The power cable according to claim 6, wherein the water barrier layer has a corrugated geometry.

12. The power cable according to claim 6, wherein the buffer layer is directly adjacent to the water barrier layer.

13. The power cable according to claim 6, wherein the liquid material of the buffer layer is a semi-conductive material.

14. The power cable according to claim 6, further comprising a polymer sheath and a second buffer layer, the second buffer layer arranged between the polymer sheath and the water barrier layer.
